(19) United States
(12) Patent Application Publication
(10) Pub. No.: US 2018/0320937 A1
(43) Pub. Date: Nov. 8, 2018

(54) TEC HEAT DISSIPATION ASSEMBLY AND PROJECTION DEVICE

(71) Applicant: APPOTRONICS CORPORATION LIMITED, Shenzhen (CN)

(72) Inventors: Gaofei DENG, Shenzhen (CN); Wei LIN, Shenzhen (CN); Jinqing LI, Shenzhen (CN)

(73) Assignee: APPOTRONICS CORPORATION LIMITED, Shenzhen (CN)

(21) Appl. No.: 15/772,397

(22) PCT Filed: Nov. 4, 2016
(86) PCT No.: PCT/CN2016/104595

§ 371 Date: Apr. 30, 2018

(30) Foreign Application Priority Data
Nov. 4, 2015 (CN) 201520874938.6

(51) Int. Cl. F25B 21/02; H01S 3/04

(52) U.S. Cl. CPC F25B 21/02; F25B 2321/023; F25B 2321/0252; H01S 3/0407

(57) ABSTRACT

A TEC heat dissipation assembly includes a TEC refrigeration module, which includes a TEC refrigeration chip, a mounting plate for mounting the TEC refrigeration chip, a water cooled plate located on one side of a heat generating surface of the TEC refrigeration chip for cooling the TEC refrigeration chip, and a cover plate for covering the TEC refrigeration module and a heat source substrate. A hollowed open window which is matched with the TEC refrigeration chip in appearance and used for allowing the heat generating surface of the TEC refrigeration chip to be in contact with the water cooled plate via the mounting plate is disposed on the surface of the mounting plate. A refrigeration surface of the TEC refrigeration chip is close to the heat source substrate at the other side of the hollowed open window. Also provided is a projection device employing the TEC heat dissipation assembly.

### BACKGROUND OF THE INVENTION

### Field of the Invention

This invention relates to a heat dissipation assembly, and in particular, it relates to a heat dissipation assembly employing TEC (thermoelectric cooler) technology, and a related projection device.

### Description of Related Art

With technological advancement, more and more highly integrated and high precision electronics devices are being developed and used, such as laser devices. Such devices impose high heat dissipation requirements during operation; sometimes, the temperature of the substrate is required to be maintained at about 20 degrees C. (typically lower than the ambient temperature). For such electronic devices that have small sizes and require precise control of environmental temperature, the core components of their heat dissipation assemblies predominantly employ TEC (thermoelectric cooler) refrigeration chips. The heat dissipation condition of the heat generating surface of the TEC chip determines its cooling performance. The lower the temperature of the heat generating surface, the higher the cooling capacity. Therefore, proper design of the heat dissipation structure for the TEC heat generating surface is particularly important.

Technical problems: In conventional TEC refrigeration designs, as shown in FIG. 1, between the heat generating surface of the TEC chip 302 and the water cooled plate 304, two layers of thermal conducting paste and a transfer mounting plate 303 are provided. Taking into account the thermal resistance of the installation, the total thermal resistance is relatively high. Moreover, because the contact surface area between the transfer mounting plate 303 and the water cooled plate 304 is relatively large, and the flatness of each plate is difficult to control, in actual installation, a relatively thick thermal conducting paste is required to be filled between them, causing the interface thermal resistance to increase. When the ambient temperature is about 35 degrees C. or higher, such an assembly often cannot meet the heat dissipation requirement of the heat source substrate 2.

### SUMMARY

Technical solutions: The present invention provides a TEC heat dissipation assembly and related projection device to solve the problems of high interface heat resistance and poor heat dissipation performance of conventional TEC heat dissipation assemblies.

A TEC heat dissipation assembly, which includes:

a TEC refrigeration module, which includes a TEC refrigeration chip, a mounting plate for mounting the TEC refrigeration chip, and a water cooled plate disposed on a side of a heat generating surface of the TEC refrigeration chip and configured to cool the TEC refrigeration chip; and

a cover plate, configured to cover the TEC refrigeration module and a heat source substrate,

wherein a surface of the mounting plate defines a hollowed open window which has a shape that matches an external shape of the TEC refrigeration chip, configured to allow the heat generating surface of the TEC refrigeration chip to be in contact with the water cooled plate through the mounting plate, and wherein a refrigeration surface of the TEC refrigeration chip is disposed adjacent to the heat source substrate to be cooled through another side of the hollowed open window.

The TEC heat dissipation assembly further includes a temperature homogenizing plate disposed on a surface of the heat source substrate, configured to conduct heat from the heat source substrate evenly to the temperature homogenizing plate, wherein one side of the temperature homogenizing plate is in contact with a heat generating region of the heat source substrate, and another side of the temperature homogenizing plate is in contact with the refrigeration surface of the TEC refrigeration chip, and wherein a surface of the other side of the temperature homogenizing plate has a flat shape that fits a shape of the refrigeration surface of the TEC refrigeration chip.

In the TEC heat dissipation assembly, the contact between the heat generating surface of the TEC refrigeration chip and the surface of the water cooled plate is mediated by a coating of a thermal conductive material.

In the TEC heat dissipation assembly, the refrigeration surface of the TEC refrigeration chip contacts the surface of the temperature homogenizing plate via a thermal conductive material coating

In the TEC heat dissipation assembly, a thermal conductive material coating is provided between the other surface of the temperature homogenizing plate and the surface of the heat source substrate.

The TEC heat dissipation assembly further includes spring bolts disposed on the heat source substrate, and the surface of the temperature homogenizing plate defines screw holes that fit the spring bolts.

The TEC heat dissipation assembly includes a plurality of TEC refrigeration chips on the surface of the mounting plate.

The TEC heat dissipation assembly includes a plurality of hollowed open windows on the surface of the mounting plate corresponding to the plurality of TEC refrigeration chips.

The TEC heat dissipation assembly includes a plurality of temperature homogenizing plates on the heat source substrate corresponding to the plurality of TEC refrigeration chips.

The TEC heat dissipation assembly further includes a sealing ring disposed between the mounting plate and the water cooled plate, and a sealing groove formed on the surface of the mounting plate that faces the water cooled plate configured to accommodate the sealing ring.

A projection device includes the above-described TEC heat dissipation assembly.

In the projection device, the heat source substrate includes a laser source.

Beneficial results: The TEC heat dissipation assembly and projection device provided by embodiments of the present invention use a structure in which the TEC refrigeration chip and the water cooled plate are in direct contact, which shortens the thermal conduction distance between the TEC refrigeration chip and the water cooled plate, and lowers the thermal resistance. A temperature homogenizing plate is provided between the TEC refrigeration chip and the heat source substrate, which prevents the problem of poor heat dissipation performance caused by uneven temperature on the refrigeration surface of the TEC refrigeration chip, and effectively extends the useful life of the device.

### BRIEF DESCRIPTION OF THE DRAWINGS

FIG. 1 schematically illustrates the structure of a conventional TEC heat dissipation assembly.

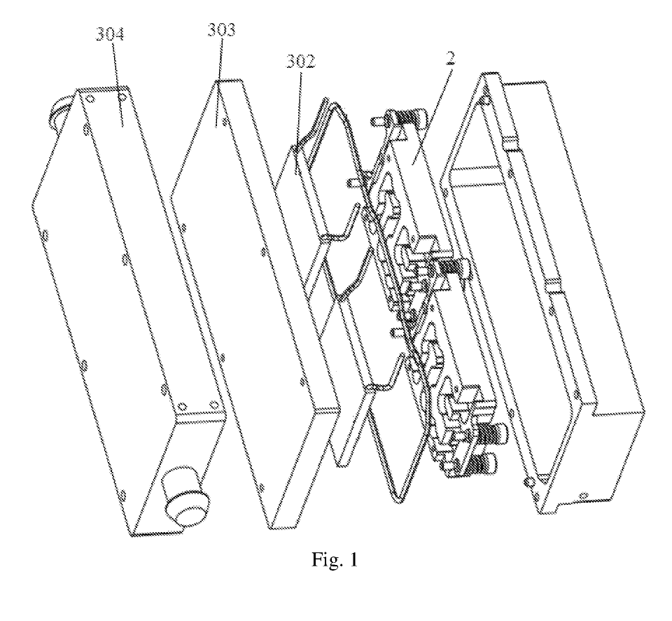

FIG. 2 schematically illustrates the structure of a TEC heat dissipation assembly according to an embodiment of the present invention.

### DETAILED DESCRIPTION OF PREFERRED EMBODIMENTS

Preferred embodiments of the present invention are described below with reference to the drawings.

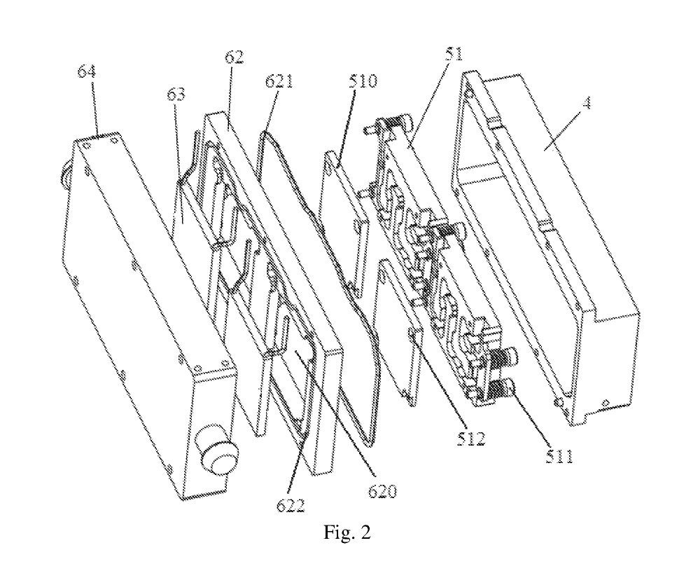

As shown in FIG. 2, the TEC heat dissipation assembly according to an embodiment of the present invention includes a TEC refrigeration module, which includes a TEC refrigeration chip 63, a mounting plate 62 for mounting the TEC refrigeration chip 63, and a water-cooled plate 64 located on the side of the heat generating surface of the TEC refrigeration chip 63 and used for cooling the TEC refrigeration chip 63; and a cover plate 4, which has a hollow cavity for accommodating a heat source substrate 51, where the cover plate 4 is affixed to the water cooled plate 64 by, for example, screws. A hollowed open window 620, having a shape that matches the external shape of the TEC refrigeration chip 63, is provide on the surface of the mounting plate 62 to allow the heat generating surface of the TEC refrigeration chip 63 to be in contact with the water cooled plate 64 through the mounting plate 62. The refrigeration surface of the TEC refrigeration chip 63 is disposed adjacent to the heat source substrate 51, which is the component that needs to be cooled, through the other side of the hollowed open window 620. Using such a structure, the TEC refrigeration chip 63 is embedded in the hollowed open window 620, such that its heat generating surface can be in direct contact with the surface of the water cooled plate 64. It is only necessary to maintain the flatness of the surface of the water cooled plate 64 and the heat generating surface of the TEC refrigeration chip 63. Compared to the conventional structure where the surface of the entire mounting plate 62 is in contact with the water cooled plate 64, it is relatively easier to maintain the flatness of the surface of the water cooled plate 64 and the heat generating surface of the TEC refrigeration chip 63. Moreover, since the TEC refrigeration chip 63 is in direct contact with the water cooled plate 64, the heat conduction path is shortened, which can ensure rapid cooling of the heat generating surface of the TEC refrigeration chip, and increase refrigeration efficiency. The contact between the heat generating surface of the TEC refrigeration chip 63 and the surface of the water cooled plate 64 is mediated by a coating of a thermal conductive material, such as a thermal grease.

Further, one shortcoming of conventional TEC heat dissipation assembly is that the refrigeration surface of the TEC refrigeration chip 63 is in direct contact with the heat source substrate 51, but the surface of the heat source substrate 51 has grooves. The result of such direct contact is that in areas where the refrigeration surface of the TEC refrigeration chip 63 contacts the heat source substrate 51, the temperature is lower, and in areas where there is no contact, the temperature is higher. This reduces the refrigeration capability of TEC refrigeration chip 63, causing the heat dissipation condition of the device to deteriorate and shortens the useful life of the device. To prevent such problems, in the present embodiment, a temperature homogenizing plate 510 is provided on the surface of the heat source substrate 51. One side of the temperature homogenizing plate 510 is in contact with the heat generating regions of the heat source substrate 51, to conduct the heat from the heat source substrate 51 evenly to the temperature homogenizing plate 510; the other side of the temperature homogenizing plate 510 is in contact with the refrigeration surface of the TEC refrigeration chip 63. Through the heat exchange between the refrigeration surface of the TEC refrigeration chip 63 and the temperature homogenizing plate 510, the temperature of the heat source substrate is reduced. The surface of the temperature homogenizing plate 510 has a flat shape that fits the shape of the refrigeration surface of the TEC refrigeration chip 63. This ensures that the refrigeration surface of the TEC refrigeration chip 63 is in complete contact with the surface of the temperature homogenizing plate 510, which prevents the uneven temperature caused by uneven contact. More specifically, the four corners of the heat source substrate 51 are provided with spring bolts 511, and the surface of the temperature homogenizing plate 510 is provided with screw holes 512 that fit the spring bolts 511. A thermal conductive material coating is filled between the temperature homogenizing plate 510 and the heat source substrate 51, so that the heat of the surface of the heat source substrate 51 is evenly conducted to the surface of the temperature homogenizing plate 510.

Preferably, when the heat source substrate 51 has multiple heat generating areas, multiple TEC refrigeration chips 63 may be correspondingly provided on the surface of the mounting plate 62; in the same way, the surface of the mounting plate 62 has multiple hollowed open windows 620 respectively corresponding to the multiple TEC refrigeration chips 63. Further, for each heat source, multiple temperature homogenizing plates 510 are provided on the surface of the heat source substrate 51. The positions of the temperature homogenizing plates 510, the hollowed open windows 620, and the TEC refrigeration chips 63 respectively correspond to each other. A sealing ring 621 is provided between the mounting plate 62 and the water cooled plate, and a sealing groove 622 for accommodating the sealing ring 621 is formed on the surface of the mounting plate 62 that faces the water cooled plate 64. Using such a structure, the TEC refrigeration chip 63 is completely sealed within the hollowed open window 620 by the thermal grease on both sides of the TEC refrigeration chip 63 and the sealing ring 621.

Further, mounting holes are provided on the peripheries of the water cooled plate 64, the mounting plate 62 and the cover plate 4. When assembling the TEC refrigeration module, the sealing ring 621 is placed in the sealing groove 622; the TEC refrigeration chip 63 is coated with a thermal grease on its heat generating surface, and is embedded in the hollowed open window 620 of the mounting plate 62. The mounting plate 62 is then placed against the surface of the water cooled plate 64, such that the heat generating surface of the TEC refrigeration chip 63 is in good contact with the surface of the water cooled plate 64 via the thermal grease. The refrigeration surface of the TEC refrigeration chip 63 is then coated with a thermal grease, and the heat source substrate 51, having the temperature homogenizing plate 510 already assembled on it, is placed against the other side of the mounting plate 62, such that the refrigeration surface of the TEC refrigeration chip 63 is in good contact with the temperature homogenizing plate 510 via the thermal grease. Lastly, the cover plate 4 is placed over the heat source substrate 51, and the screws are screwed in to securely affix the cover plate 4, the mounting plate 62 and the water cooled plate 64 to each other, forming a sealed space within. This prevents the components inside the sealed space from direct contact with the outside air, preventing condensation inside.

Based on the above-described embodiment, this invention further provides a projection device, which includes the TEC heat dissipation assembly described above. The heat source being cooled by the heat dissipation assembly may be a laser source of the projection device of this embodiment, or other components.

The TEC heat dissipation assembly and projection device provided by embodiments of the present invention use a structure in which the TEC refrigeration chip and the water cooled plate are in direct contact, which shortens the thermal conduction distance between the TEC refrigeration chip and the water cooled plate, and lowers the thermal resistance. A temperature homogenizing plate is provided between the TEC refrigeration chip and the heat source substrate, which prevents the problem of poor heat dissipation performance caused by uneven temperature on the refrigeration surface of the TEC refrigeration chip, and effectively extends the useful life of the device.

While the embodiments of the present invention are described in detail above, the invention is not limited to these embodiments. It will be apparent to those skilled in the art that various modification and variations can be made in the apparatus of the present invention without departing from the spirit or scope of the invention.

1. A TEC (thermoelectric cooler) heat dissipation assembly, comprising:
a TEC refrigeration module, which includes a TEC refrigeration chip, a mounting plate for mounting the TEC refrigeration chip, and a water cooled plate disposed on a side of a heat generating surface of the TEC refrigeration chip and configured to cool the TEC refrigeration chip; and
a cover plate, configured to cover the TEC refrigeration module and a heat source substrate,
wherein a surface of the mounting plate defines a hollowed open window which has a shape that matches an external shape of the TEC refrigeration chip, configured to allow the heat generating surface of the TEC refrigeration chip to be in contact with the water cooled plate through the mounting plate, and wherein a refrigeration surface of the TEC refrigeration chip is disposed adjacent to the heat source substrate to be cooled through another side of the hollowed open window.

2. The TEC heat dissipation assembly of claim 1, further comprising a temperature homogenizing plate disposed on a surface of the heat source substrate, configured to conduct heat from the heat source substrate evenly to the temperature homogenizing plate, wherein one side of the temperature homogenizing plate is in contact with a heat generating region of the heat source substrate, and another side of the temperature homogenizing plate is in contact with the refrigeration surface of the TEC refrigeration chip, and wherein a surface of the other side of the temperature homogenizing plate has a flat shape that fits a shape of the refrigeration surface of the TEC refrigeration chip.

3. The TEC heat dissipation assembly of claim 1, wherein the contact between the heat generating surface of the TEC refrigeration chip and the surface of the water cooled plate is mediated by a coating of a thermal conductive material.

4. The TEC heat dissipation assembly of claim 2, further comprising a thermal conductive material coating located between the refrigeration surface of the TEC refrigeration chip and the surface of the temperature homogenizing plate and/or between the other surface of the temperature homogenizing plate and the surface of the heat source substrate.

5. The TEC heat dissipation assembly of claim 2, further comprising spring biased screws disposed on the heat source substrate, and the surface of the temperature homogenizing plate defines screw holes that fit the spring biased screws.

6. The TEC heat dissipation assembly of claim 2, comprising a plurality of TEC refrigeration chips, a plurality of hollowed open windows on the surface of the mounting plate, and a plurality of temperature homogenizing plates, respectively corresponding to each other.

7. The TEC heat dissipation assembly of claim 4, further comprising a sealing ring disposed between the mounting plate and the water cooled plate, and a sealing groove formed on the surface of the mounting plate that faces the water cooled plate configured to accommodate the sealing ring.

8. A projection device, comprising the TEC heat dissipation assembly of claim 1.

9. The projection device of claim 8, wherein the heat source substrate includes a laser source.

10. The TEC heat dissipation assembly of claim 2, wherein the contact between the heat generating surface of the TEC refrigeration chip and the surface of the water cooled plate is mediated by a coating of a thermal conductive material.

11. The TEC heat dissipation assembly of claim 5, further comprising a sealing ring disposed between the mounting plate and the water cooled plate, and a sealing groove formed on the surface of the mounting plate that faces the water cooled plate configured to accommodate the sealing ring.

12. The TEC heat dissipation assembly of claim 6, further comprising a sealing ring disposed between the mounting plate and the water cooled plate, and a sealing groove formed on the surface of the mounting plate that faces the water cooled plate configured to accommodate the sealing ring.
